(19) United States
(12) Patent Application Publication
(10) Pub. No.: US 2017/0221031 A1
(43) Pub. Date: Aug. 3, 2017

(54) Computer Systems, Methods and Software for Making Purchases

(71) Applicant: MASTERCARD INTERNATIONAL INCORPORATED, Purchase, NY (US)

(72) Inventors: Gurpreet Atwal, Somers, NY (US); Vipul Mehrotra, Haryana (IN); Jaipal Kumawat, Haryana (IN)

(21) Appl. No.: 15/423,058

(22) Filed: Feb. 2, 2017

(30) Foreign Application Priority Data
Feb. 3, 2016 (SG) 10201600834W

(51) Int. Cl. G06Q 20/18; G06Q 20/34; G06Q 30/06; G06Q 30/02

(52) U.S. Cl. CPC G06Q 20/18; G06Q 30/0226; G06Q 20/34; G06Q 30/0635

(57) ABSTRACT

A software application is installed in a mobile communication device. A consumer at a retail location carries the communication device. As the consumer selects items for purchase, product information is successively entered into the communication device to notify the application of the products which the consumer selects. The application uploads the product information to a server of the merchant which operates the retail location. The communication functionality of the communication device is used to notify the consumer of product offers, and/or communicate to the consumer reward information relating to consumer rewards offered to the consumer for making the purchases.

### CROSS-REFERENCE TO RELATED APPLICATION

This application claims the benefit of and priority to Singapore Patent Application No. 10201600834W, filed Feb. 3, 2016. The entire disclosure of the above application is incorporated herein by reference.

### FIELD

The present disclosure relates to computer systems and computer-implemented methods for handling purchases at a retail location.

### BACKGROUND

This section provides background information related to the present disclosure which is not necessarily prior art.

It is increasingly common for a retail location, such as a supermarket, to provide self-service check-out equipment which consumers can use to purchase items they have previously selected. The consumers are required to present their selected items successively to an imaging device of the self-service check-out equipment. The self-service check-out equipment recognizes the products from images captured by the imaging device, and calculates the total the consumer has to pay to purchase them. Typically, once this process is completed, the consumer purchases the items using a payment card, which is read automatically by the self-service check-out equipment.

By providing such a facility, the operator of the retail location (the “merchant”) can reduce its labor costs in employing human check-out operators. However, the self-service check-out equipment is expensive for the merchant to purchase or rent. The merchant also has to pay for the space at the retail location which the equipment occupies, and the space consumers use while interacting with the equipment. At busy times, consumers may have to queue for a considerable time to use the self-service check-out equipment.

Furthermore, a consumer sees little advantage to himself or herself from using this facility rather than a human check-out operator. The step of presenting successive items to be imaged is tedious, and many consumers find it less pleasant than interacting with a human check-out operator. Consumers are inclined to be irritated by any delay or failure in the operation of the self-service check-out equipment. In supermarkets, which give consumers the option of using either a self-service check-out facility or a human check-out operator, it is common for a queue of consumers to form in front of the human check-out operator, while the self-service check-out equipment remains unused.

### SUMMARY

This section provides a general summary of the disclosure, and is not a comprehensive disclosure of its full scope or all of its features. Aspects and embodiments of the disclosure are also set out in the accompanying claims.

The present disclosure aims to provide new and useful computer systems, computer-implemented methods and computer program products, to facilitate purchases at a retail location.

In general terms, the disclosure proposes that a software application (an “app”) is installed in a mobile communication device associated with the consumer. Using the software application, as the consumer selects product items for purchase in a retail location, product information is successively entered into the communication device to notify the application of the products which the consumer selects. The communication device transmits the product information to a server (“merchant server”) associated with the merchant. The communication functionality of the communication device is used to perform one or both of (i) notifying the consumer of product offers, and (ii) communicating to the consumer reward information relating to consumer rewards offered to the consumer for making the purchases.

In contrast to a conventional self-service check-out system using self-service equipment provided by a retailer, the present disclosure avoids the need for the retailer to provide self-service check-out equipment, since the list of selected products is generated by the communication device of the consumer. Also, the merchant does not have to provide the space in the retail location occupied by the self-service check-out equipment.

The information provided to the consumer by the communication functionality of the communication device helps the consumer to select items. This is advantageous compared to receiving the information later (e.g. during a check-out procedure, when it is inconvenient for the consumer to return to the areas of the retail location where products are displayed). For example, a consumer using an embodiment of the disclosure who has selected a certain number of units of a certain product may be notified very shortly afterwards (e.g. a few seconds later) of a product offer by which further units of the same item, or a related item, may be purchased at a reduced price. In other words, the consumer may be notified of the offer while he or she is still in the area of the retail location where the item is available to be selected. Thus, the consumer may recognize a significant advantage from using an embodiment of the present disclosure, compared to self-service check-out equipment provided by the retailer.

In another example, the information about rewards may notify a consumer who is enrolled with a loyalty program of how many loyalty points the consumer has accumulated, or notify the consumer about a reward which the consumer has earned by accumulating loyalty points to encourage him to make a further product selection.

Furthermore, the information may notify the consumer of a reward which is not linked to a loyalty program: such as a reward which is given to all consumers who purchase a certain product, or a reward which is given to a certain random proportion of consumers who purchase a certain product.

The consumer obtains further advantages from using the software application. First, the communication device can keep a running total of the cost of items as they are selected. This can help the consumer to avoid exceeding a budgeted amount.

Secondly, a consumer who has used the software application before in another retail location (e.g. one operated by a different merchant), will have gained a certain familiarity with it. He or she may therefore prefer using the software application again, to working out how to use unfamiliar self-service check-out equipment provided by the merchant.

Thirdly, the consumer does not have to wait for either a human check-out operator or self-service check-out equipment to become available.

The communication device may contain, or be able to access, a database which stores purchase receipts and/or a shopping history. This is convenient for the consumer, who in many conventional systems receives only a paper receipt, which is easy to lose. Furthermore, it is valuable for the merchant, and any other organization which is able to access the database, to obtain detailed information about what the consumer has purchased. The data may identify the purchased product(s) in terms of stock-keeping units (SKU) according to a predefined inventory system. Conventionally an SKU is an identification code which allows an individual product of the inventory system to be tracked.

The database may additionally or alternatively store information about the loyalty programs with which the consumer is enrolled, such as the number of accumulated loyalty points the consumer has accumulated on one or more of the programs. The database may be updated by the merchant server upon the consumer making a purchase. The reward described by the reward information may be one or more loyalty points. Alternatively, it may be a product available to the consumer taking into account previously accumulated loyalty points.

Conveniently, the product information which is entered into the communication device to notify the software application of a product selected by the consumer, may be entered at least partly by an automatic process. In one possibility, the consumer may enter the product information into the communication device by using an imaging unit of the communication device to capture an image of a graphical symbol (such as a barcode or quick response (QR) code) displayed on or in the proximity of the product. The graphical symbol encodes the product information. Optionally, the consumer may make a manual input to confirm that the right product has been identified and/or to notify the software application of the number of units of the product which the consumer wishes to purchase.

Upon completing the selection of items, the consumer may be able to purchase all of the items. Optionally, this may be done automatically, by interaction between the communication device and the merchant server, such as by using payment card data relating to a payment card associated with the consumer, and with a payment account maintained by the consumer at a financial institution (e.g. a bank). The payment card data may be pre-stored in the communication device, for example, and transmitted out of the communication device during the payment procedure, e.g. to the merchant server.

As used in this document, the term “payment card” refers to any cashless payment device associated with a payment account, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers.

Alternatively, the consumer may be able to pay for the selected items by interacting with a cash receiving unit provided by the merchant. The cash receiving unit is operative to receive a cash payment made by the consumer in respect of the product(s) the consumer has selected and registered using the software application. This option is particularly useful in the case of consumers who do not have access to a payment card. The cash receiving unit is preferably operative to communicate with the store server to obtain the amount of cash which the consumer should pay. The cash receiving unit may further be operative to communicate with the communication device, such as to receive automatically from the communication device identity information which enables the cash receiving equipment to associate the cash payment with the communication device.

In either case, a record is generated, e.g. in a database of the merchant server, of the products which were purchased.

Once the payment has been made, the consumer may leave the retail location. A scanner may be provided at the exit to scan the product(s) which the consumer takes out the retail location, and compare them to the record of the products which were purchased. Alternatively, selected consumers may be approached by security staff and asked to demonstrate that the products they are carrying are those which were purchased. The consumers may be selected using a surveillance system which attempts to detect when a consumer places a product into a shopping basket without notifying the software application of that selection.

The term “product” is used here to include physical objects, but also digital products (such as software or data encoding music or a film) and even services.

The term “automatic” in relation to a processing step means the processing step is carried out substantially without human involvement, save possibly for causing the processing step to be performed.

The disclosure may be expressed in terms of a communication device, or method it performs. It may further be expressed as a computer program product, such as one stored in non-transitory form on a tangible data storage device, comprising program instructions operative to cause the processor of the communication device to perform the method. The disclosure may also be expressed in terms of the merchant server, or the method it performs. It may furthermore be expressed in terms of a computerized network comprising both the communication device and the merchant server, or the method it performs.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, an embodiment of the disclosure will now be described with reference to the following drawings in which:

FIG. 1 shows a computerized network which is an embodiment of the disclosure;

FIG. 2 shows steps of a method which is an embodiment of the disclosure;

FIG. 3 shows a communication device of the computerized network of FIG. 1 communicating with two servers using a communication network;

FIG. 4 shows the structure of one of the servers of FIG. 3; and

FIG. 5 shows schematically the structure of the communication device of the computerized network of FIG. 1.

### DETAILED DESCRIPTION

Embodiments of the present disclosure will be described, by way of example only, with reference to the drawings. The description and specific examples included herein are intended for purposes of illustration only and are not intended to limit the scope of the present disclosure Like reference numerals and characters in the drawings refer to like elements or equivalents.

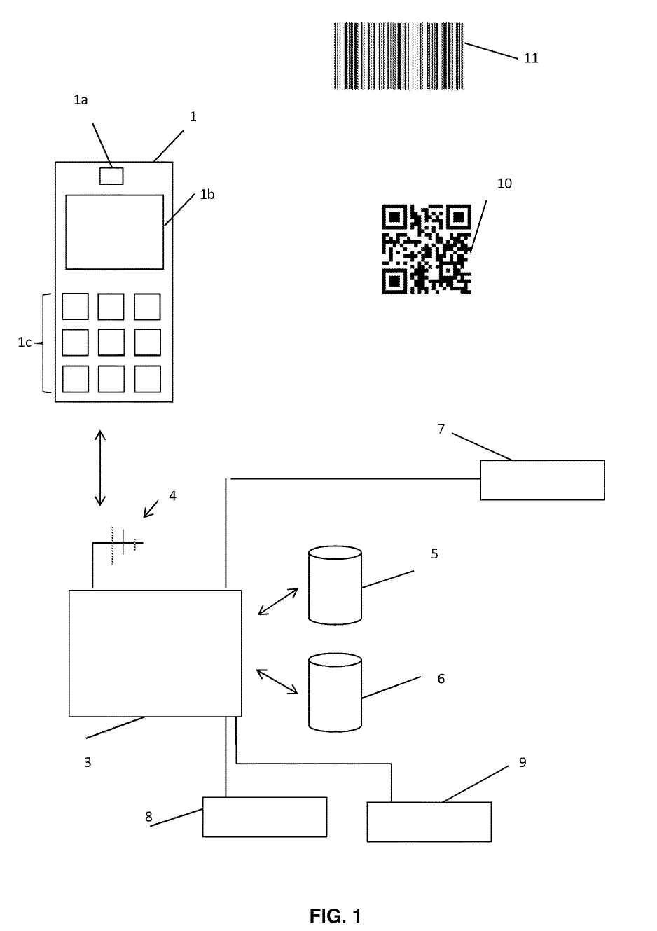

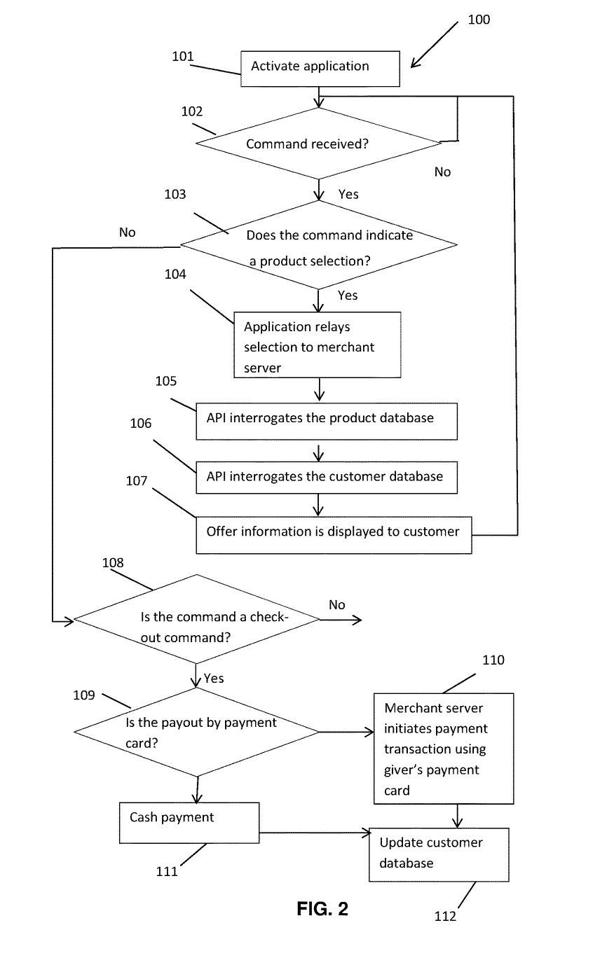

Referring firstly to FIG. 1, a computerized network is shown which can perform an embodiment of the disclosure which is the method illustrated in FIG. 2.

As shown in FIG. 1, a consumer at a retail location (that is, a location where a merchant offers products for sale, such as a supermarket or other retail store) uses a mobile communication device 1 which may be a smart phone or a tablet. The communication device 1 includes an installed software application, which is configured to interact with a merchant server 3 operated by the merchant by bi-directional communication.

FIG. 1 shows only a single communication device 1, but it is to be understood that there will typically be a plurality of consumers simultaneously interacting with the merchant server 3. Each consumer is associated with a respective communication device.

The communication device 1 associated with a given consumer may be owned by the consumer. It is typically brought to the retail location by the consumer, although in principle it would be possible for the merchant to provide communication devices at the retail location for consumers to use while in the retail location.

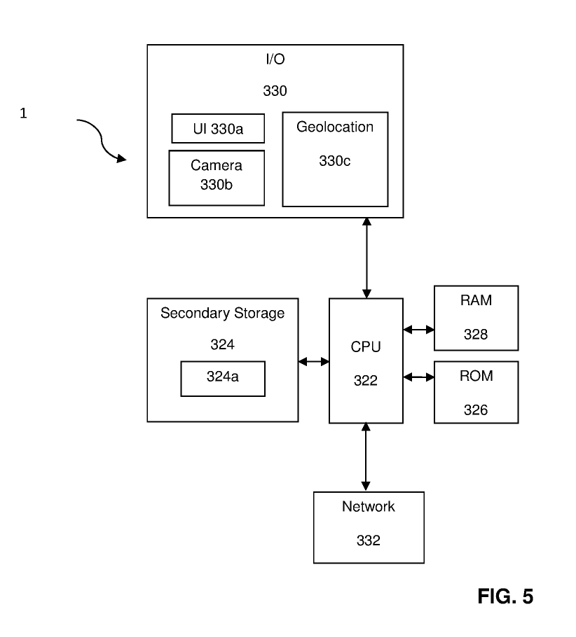

The communication device 1 includes a camera 1a and a screen 1b, which may be touch-sensitive. The communication device 1 may include additional data input devices, such as a keyboard 1c. The communication device 1 further includes an aerial for wireless communication using a wireless communication interface of the communication device 1. The structure of the communication device 1 is explained in more detail below with reference to FIG. 5.

The communication between the communication device 1 and the merchant server 3 may be via any communication system. In one example, it may be using a WiFi network provided by the merchant at the retail location using an aerial 4 coupled to the merchant server 3. In an alternative example, the communication network may be a network provided by one or more external communication network providers, such as telecom company(s), with the communication device 1 and server 3 both being independently connected to the communication network.

The merchant server 3 runs an application programming interface (API) for communicating with the software application on the communication device 1. The API is able to access a product database 5 storing information about the products for sale at the retail location. The product database 5 further contains information about offers relating to the products.

The merchant server 3 accumulates data relating to the consumer (e.g. data received from the communication device 1) in a consumer database 6. The consumer database 6 may further store information about loyalty programs in which the consumer is enrolled, and the number of loyalty points the consumer has accumulated. The consumer database 6 may further store characterization data characterizing the consumer. The characterization data may include historical information about previous payment transactions the consumer has made to the merchant. The characterization data may further include demographic data about the consumer, such as the consumer's age, gender, income bracket, etc.

The server 3 may be further coupled to additional devices, typically provided by the merchant. These devices may include at least one cash receiving unit 7 for receiving a cash payment from a consumer. The devices may further include at least one surveillance unit 8 for monitoring products consumers select. The devices may further include at least one scanner unit 9 provided at an exit of the retail location for scanning products the consumer removes from the retail location.

Turning to FIG. 2, the steps of a method 100 according to the disclosure are shown. Upon the consumer entering a retail location, the consumer activates the software application and the software application performs an initialization process (step 101). During the initialization process, the software application establishes a communication channel with the merchant server 3.

Optionally, particularly in the case that this is the first time that the software application has been used in this retail location, the software application may upload information about the consumer into the consumer database 6. Alternatively or additionally, the software application may instruct the merchant server 3 to access a database remote from the merchant server 3 (e.g. one stored on the cloud) to populate the consumer database 6.

Optionally, step 101 may include the merchant server 3 interrogating the product database 5, for example using data relating to the consumer in the consumer database 6, to obtain information about product offers which are appropriate to the consumer. In this case, the information about the product offers is relayed to the software application, and the software application displays the information on the screen 1b.

The application enters a state in which it awaits an instruction from the consumer. In step 102 it determines whether such a command has been received. If not, the software application loops back to step 102.

The consumers may enter several types of commands. One of these types of commands is a command telling the application to register a product which the consumer has selected to purchase later. This type of command is recognised in step 103, at substantially the same time the consumer picks up the product, or puts it into a physical shopping trolley or a shopping basket carried by the consumer.

The command includes product information indicative of the product. The product information may be information identifying the product according to a pre-determined inventory system. For example, the product information may be an SKU code. Conveniently, the consumer may issue the command by using the camera 1a to capture an image of a quick response (QR) code 10 (or equivalently, another type of matrix barcode, such as Data Matrix, EZcode, Han Xin barcode or Shotcode) or a barcode 11 displayed on the product or proximate to the product. The QR code 10 or barcode 11 encodes the product information. The software application extracts the product information in the SKU format from the captured image.

In step 104, the application relays the product information to the API on the merchant server 3.

Note that in a variation of the embodiment, in step 104, the communication device 1 uploads the raw image captured by the camera 1a to the merchant server 3 which itself extracts the product information from it.

Other variations of steps 103 and 104 are possible also within the scope of the disclosure. For example, instead of providing an image 10, 11 on or near each available product, the merchant may provide a signal transmission unit (e.g., a near-field communication (NFC) tag or Bluetooth Low Energy (BLE) tag) which emits a short-range wireless signal (e.g. an electromagnetic signal, such as a radio-frequency (RF) or infra-red signal) which encodes the product information. In this case, the consumer may optionally issue the product selection command by bringing the communication device into close proximity with the signal emission unit, so that the communication device 1 can receive the wireless signal.

In step 105, the API uses the product information to interrogate the product database 5 to extract information relating to the product, in particular the price of the selected product.

The merchant server 3 uses the extracted information to update a virtual “shopping basket” (i.e. a data-set which is a list of products selected by the consumer), which may be stored on the communication device 1 or in the database 6. Typically, it is stored in both. The price of each selected product is used to update a running total of the cost of the selected product(s) in the virtual shopping basket(s). This may be displayed to the consumer using the screen 1b of the communication device 1.

Optionally the merchant server 3 may additionally receive surveillance information from the consumer surveillance equipment 8 indicating that the consumer has selected a product. If the merchant server 3 receives such surveillance information without receiving a corresponding product selection command in step 104, then an alert may be triggered, e.g. for the consumer's activity to be monitored by a human operator.

The interrogation of the product database 5 by the AIP in step 105 further includes the merchant server 3 determining whether the product database 5 contains relevant offer information associated with the product, and specifying an offer in relation to the product. For example, the offer may be that if a certain number of additional units of products are purchased, a discount is provided. Alternatively, the offer may be that another product can be obtained as a discounted price (e.g. an offer relevant to a first product, which is a bottle of dish washing liquid, may be to discount a certain dish cloth).

Optionally, there may be a step 106 of interrogating the consumer database 6, and using the data extracted from the consumer database 6 determining whether an offer extracted from the product database 5 in step 105 is compatible with the data stored in the consumer database 6 relating to the consumer. This would be useful, for example, if the offers in the product database 5 are dependent upon the consumer meeting one or more criteria. These criteria may include:
a. whether the consumer has purchased a certain number of units of a product from the retailer in the past. This can be determined using the historical data in the consumer database 6;
b. whether the consumer is enrolled in a certain loyalty program, or has collected a certain number of points in that program; and/or
c. whether the demographic data relating to the consumer in the consumer database 6 meets one or more criteria. For example, certain product offers are statistically more likely to be of interest to consumers with certain demographic characteristics.

In step 107, the relevant offer data, if any exists (and if it has been determined to be compatible with the consumer in optional step 106), is passed to the communication device 1, which displays it to the consumer on screen 1b.

The method then returns to step 102 which is performed repeatedly until another command is received. For example, enticed by the displayed offer data, the consumer may make a further product selection command, which would then be detected in steps 102 and 103. This command might, for example, be to register a selection of additional units of the previously selected product. If so, this command may be made by data input to the communication device 1, rather than re-scanning the images 10, 11. At substantially the same time, the consumer picks up the additional units of the product, or puts them in his/her shopping trolley or basket.

If it is determined in step 103 that the command recognised in step 102 is not a product selection, the method passes to step 108. In step 108 it is determined whether the command is a command to initiate a check-out procedure. If not, the method may include additional steps (not shown) of recognising another type of command, and implementing it. After this the method returns to step 102. The other type of command may, for example, be a command to display information from the consumer database 6, such as the number of loyalty points the consumer has accumulated in a certain loyalty program.

Another command which the consumer may be able to issue is a command to remove a previously selected product from the virtual shopping basket. The consumer uses this command when he or she puts the previously selected product back in a display location. Upon recognising this command, the communication device 1 notifies the merchant server 3, which updates the consumer database 6. A consumer may choose to remove a product from their shopping basket, for example, because the running total of their purchases is too high for the consumer to be comfortable. Note that this option is much less embarrassing and time-consuming than when, in a conventional check-out system, the consumer decides not to buy a certain product which the consumer had previously selected.

Alternatively, if it is determined in step 108 that the command is indeed a command to initiate a check-out procedure, in step 109, the system determines whether this check-out will include the consumer paying for the selected products using a payment card. The determination may be done, for example, by checking payment preferences pre-entered by the consumer and stored in the communication device 1 and/or the consumer database 6. Alternatively, the communication device 1 may request user input to determine how the payment is to be made, e.g. by displaying a message on the screen 1b asking the consumer how the payment will be made, and then awaiting data input using the screen 1b or the keyboard 1c.

If it is determined in step 109 that the payment is to be by payment card, then the merchant server 3 implements the payment in step 110. This may include asking the consumer to enter payment card data into the communication device 1, or by extracting pre-stored payment card data from the communication device 1 and/or the consumer database 6.

The payment card data is data sufficient to identify (at least to the issuer) the payment account associated with the payment card. Optionally, the payment card data may be a conventional payment account number (PAN), as well as an expiry date of the payment card. In variants of the method, the payment card data may be a token issued by the issuer bank, and stored in a database of the issuer bank associated with details of the consumer's payment account, such that the issuer bank is able to identify the payment account from the token.

The payment API of the merchant server 3 contacts an acquirer bank at which the merchant maintains an account, and transmits to the acquirer the payment card data and the payment amount.

The acquirer initiates a process in which payment is obtained from the issuer bank which issued the payment account, according to a conventional payment procedure. For example, the acquirer may contact the server (not shown) of a payment account network, which forwards a request for payment to the issuer. The issuer initiates an authorization process for deciding whether to authorize the payment. Upon the payment being authorized, the issuer debits the payment amount (optionally plus a handling charge) to the payment account associated with the payment card, and schedules a payment to the acquirer (typically as part of a subsequent clearing operation). Whether the payment is authorized or declined, the issuer notifies the payment network of its decision, the payment network relays this information to the server of the acquirer bank, which relays this information to the merchant server 3. If the payment was authorized, the acquirer credits the payment amount (optionally minus a handling charge) to the payment account associated with the merchant. The merchant server 3 transmits a message to the software application indicating whether the payment authorization process was successful or declined. If the response is positive, then the acquirer bank credits a payment to the payment account of the merchant, and the issuer bank schedules a payment to the acquirer bank (e.g. during a subsequent clearing operation).

Thus, the consumer is able to pay for the selected products without going to a check-out location, and without queuing. The payment may be done anywhere in the retail location, e.g. “in aisle”, with the consumer's own communication device 1 acting as a mobile point-of-sale terminal. There will be virtually no wait time, unlike a conventional check-out process.

In one possibility, the payment authorization process may include the communication device 1 entering into communication (e.g. initiated by the merchant server 3) with a mobile wallet server associated with a financial institution, such as the issuer bank. This communication may be using a separate communication network from the WiFi network operated by the retailer. The consumer may previously have registered one or more payment cards with the mobile wallet server. The consumer may then communicate with the mobile wallet server to perform an authentication operation to verify the identity of the consumer (e.g. by the consumer entering a pre-agreed password, or a one-time-authorization code (OTAC) transmitted by the mobile wallet server to a short messaging service (SMS) application running on the communication device 1). In this way, the payment transaction process can be integrated with the conventional process performed by a mobile wallet server.

Alternatively, if it is determined in step 109 that the payment not be made using a payment card, then in step 111 the consumer approaches a cash receiving unit 7. The communication device 1 may communicate with the cash receiving unit 7 to identify the communication device 1 (that is, the consumer). Once this is done, the communication device 1 typically communicates with the merchant server 3 to determine the amount of cash the consumer has to pay for the selected items, and displays it to the consumer. The cash receiving unit 7 interacts with the consumer to receive this amount of cash. The cash receiving unit 7 notifies the merchant server 3 that this payment has been received.

Following the payment being performed successfully in either of steps 110 or 111, the consumer database 6 is updated to indicate this fact (step 112). This may include updating loyalty point information in the consumer database 6. This loyalty point information may be displayed to the consumer, e.g. by relaying it from the consumer database 6 to the software application on the communication device 1, which controls the screen 1b accordingly.

Preferably, an electronic bill of sale (“receipt”) is generated in step 112 which the consumer can use as proof of purchase. The electronic bill of sale may be generated by the communication device 1 or by the merchant server 3. The electronic bill of sale may be stored in the communication device 1 and/or in the consumer database 6.

Following the performance of the method 100, the consumer may attempt to exit the retail premises. At this stage the scanning unit 9 may scan the product(s) the consumer is taking out of the retail premises (e.g. using RFID tags attached to the products which can be read by an RFID signal reader which is part of the scanning unit 9). The data is passed to the merchant server 3 which checks that the products being removed correspond to those which were paid for. If the merchant server 3 determines that there is any discrepancy, a security protocol is initiated, e.g. by alerting a human security guard. The human security guard can obtain from the merchant server 3 the record of the purchased products, and verify that the items listed there are the ones the consumer is removing from the retail location.

Optionally, such a check can be done for selected consumers (e.g. for randomly selected consumers) even if no alert has been generated automatically. Thus, in some embodiments of the disclosure the scanning unit 9 may be omitted.

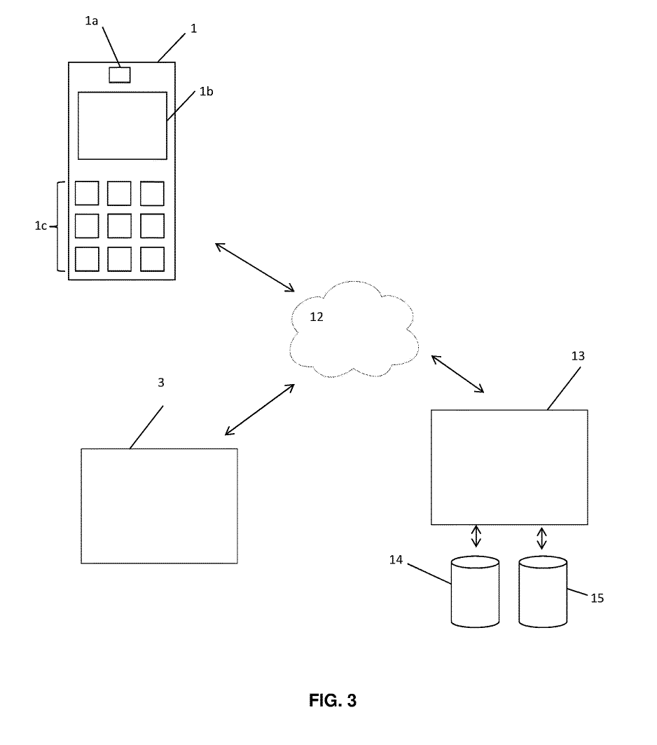

Turning to FIG. 3, a system is shown which illustrates alternative modes of use of the communication device 1. The communication device 1, in this case, is in communication with a telecommunications network 12, such as the internet. In this way, the communication device 1 can selectively communicate with the merchant server 3 or with a provider server 13 operated by an organisation which provides the software application. The provider server 13 may include an individual database 14 which stores information characterizing individuals, such as demographic information relating to the individuals.

Note that one possibility is for the software application to be provided to the consumer by the merchant, in which case servers 3 and 13 may be a single server. In this case, the individual database 15 may be identical to the consumer database 6 of FIG. 1.

However, more preferably, the provider is a trusted financial institution, such as the bank which issued the consumer's payment card, or a server operated by a payment network associated with the payment card.

First we describe the procedure by which the software application is installed into the communication device 1. The consumer uses the communication device to contact the provider server 13. The communication device 1 downloads the software application from the provider server 13.

At that time, the consumer may enter details in the software application of any rewards programs of which the consumer is already a member. This may be done, for example, by the consumer entering the details of the rewards programs into the communication device 1 manually. Alternatively, it may be done by using the communication device 1 to scan an image generated by an operator of the rewards program. The process may include the software application being provided with a membership number of the consumer in the rewards program. The information is stored by the provider server 13 in the individual database 14. Optionally, step 101 of the method 100 described above with reference to FIG. 2 includes the merchant server 3 contacting the server 13 and obtaining this information to populate part of the consumer database 6. Thus, the consumer does not have to bring details of his or her loyalty programs (e.g. physical loyalty card(s)) to the retail location, and yet can be sure that loyalty points will correctly accumulate for any products which are purchased.

Optionally, the server 13 may suggest rewards programs for the consumer to enroll with. The server 13 may store details of these rewards programs in a database 15, and may be operative to make a selection of an appropriate rewards program to suggest to the consumer based on the data relating to the consumer in the individual database 14.

Optionally, after the software application is installed in the communication device 1, the software application and the server 13 may communicate at intervals. For example, the software application may be configured to commence communication with the server 13 at intervals according to a pre-defined timetable (or, if the communication device 1 is not connected to the communication network 12 at any of these pre-defined times, upon the communication device 1 next being connected to the communication network 12). At these times, the server 13 may interrogate the database 15 to obtain data relating to promotional programs (e.g. seasonal rewards programs during the holiday season), such as ones relating to merchants at which the consumer has previously used the software application. At an appropriate time, the software application may display information about these promotional programs to the consumer using the screen 1b.

Another mode of operation of the communication device 1 is to make online purchases from the merchant server 3, using the software application on the communication device 1. The API of the merchant server 3 is configured to permit this process, according to conventional online store techniques. Once the purchase is complete, a record of the purchase may be stored in the communication device 1 and in the customer database 6 just as for the in-store purchase method 100 described above with reference to FIG. 2.

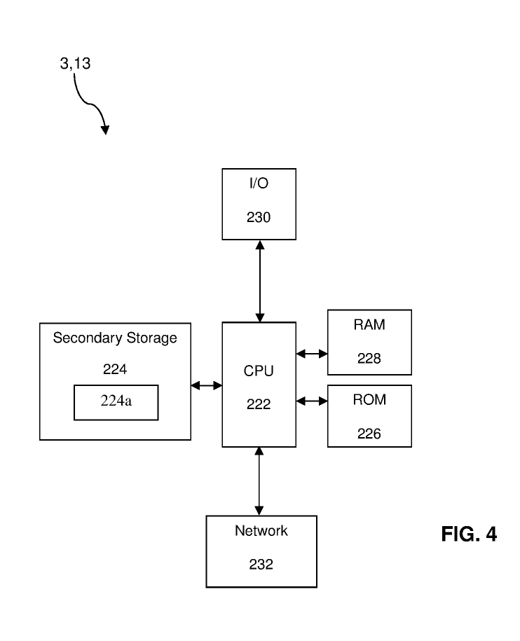

FIG. 4 is a block diagram showing a technical architecture of the merchant server 3. The provider server 13 may also have this technical architecture.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 5 is a block diagram showing a technical architecture of the communication device 1. It is envisaged that in embodiments, the communication device 1 will be a smartphone or tablet device.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a consumer to capture images and save the captured images in electronic form. The geolocation module 330c is operable to determine the geolocation of the communication device using signals from, for example, global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a processing component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present disclosure.

With that said, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of registering products selected by a consumer at a retail location operated by a merchant, the method comprising:
(a) receiving, by a communication device, respective product information indicative of one or more products successively selected by the consumer at the retail location;
(b) transmitting the product information out of the communication device over a communications network;
(c) receiving information over the communications network;
(d) displaying the received information to the consumer; and
(e) upon receiving a consumer command, initiating a payment process in which a payment is made for the selected items;
wherein the information is selected from the group comprising:
(i) offer information notifying the consumer of product offers, and
(ii) reward information relating to a reward offered to the consumer for making purchases.

2. The method according to claim 1, wherein the offer information is an offer to sell to the consumer a certain number of units of the product described by the product information.

3. The method according to claim 1, wherein the reward offered to the consumer is one or more loyalty points in a customer loyalty program, and the reward information identifies the number of points; and/or
wherein the reward offered to the consumer is a reward which the consumer may obtain using previously accumulated loyalty points.

4. (canceled)

5. The method according to claim 1, further comprising:
storing, by the communication device, a list of the selected product items; and
storing and displaying a cumulative price of the selected product items.

6. The method according to claim 1, further comprising:
transmitting, by the communication device, the product information to a merchant server associated with the merchant;
interrogating, by the merchant server, an offer database using the product information, and thereby extracting from the offer database the information received by the communication device over the communications network; and
after completion of the payment process, updating, by the merchant server, a record of loyalty points accumulated by the consumer in a predefined loyalty program.

7. (canceled)

8. The method according to claim 1, further comprising, upon completion of the payment process, generating a digital record of the payment and the purchased products, and storing the electronic record in a digital database.

9. The method according to claim 1, wherein the product information is entered into the communication device by an imaging unit of the communication device capturing an image of a graphical symbol displayed on or proximate to the product; and
further comprising extracting, by the communication device, the product information from the captured image in the form of a code number according to a predefined inventory system.

10. (canceled)

11. The method according to claim 1, wherein the payment process initiated by the communication device employs payment card data of a payment card associated with the consumer; and
further comprising, in connection with the payment process, transmitting, by the communication device, identity information to a cash receiving unit.

12.-18. (canceled)

19. A non-transitory computer readable storage media including executable instructions, which, when executed by a processor of a communication device used by a consumer at a retail location operated by a merchant, causes the processor:
(a) to receive respective product information indicative of one or more products successively selected by the consumer at the retail location;
(b) to transmit the product information out of the communication device over a communications network;
(c) to receive information transmitted over the communications network;
(d) to display the received information to the consumer using the screen; and
(e) upon receiving a consumer command, to initiate a payment process in which a payment is made for the selected items;
wherein the information is selected from the group comprising:
(i) offer information notifying the consumer of product offers, and
(ii) reward information relating to a reward offered to the consumer for making purchases.

20. The non-transitory computer readable storage media according to claim 19, wherein the executable instructions, when executed by the processor, further cause the processor:
to store a list of the selected product items;
to calculate a cumulative price of the selected product items; and
to display the cumulative price using the screen.

21. The non-transitory computer readable storage media according to claim 19, wherein the executable instructions, when executed by the processor, further cause the processor:
to obtain the product information in the form of an image captured by an imaging unit of the communication device; and
to extract the product information from the captured image in the form of a code number according to a predefined inventory system.

22. (canceled)

23. The non-transitory computer readable storage media according to claim 19, wherein the executable instructions, when executed by the processor, further cause the processor to transmit payment card data stored in the communication device out of the communication device.

24. The non-transitory computer readable storage media according to claim 19, wherein the executable instructions, when executed by the processor, further cause the processor to transmit identity information out of the communication device to a cash receiving unit.

25. A computerized network for registering products selected by a consumer at a retail location operated by a merchant, the computerized network comprising:
(i) a communication device associated with the consumer, the communication device being operative to:
receive respective product information indicative of one or more products successively selected by the consumer at the retail location; and
transmit the product information out of the communication device over a communications network;
(ii) a merchant server operative to receive the transmitted information, the merchant server comprising at least one database selected from the group comprising:
a product database storing offer information characterizing offers to supply products; and
a consumer database storing information about one or more loyalty programs in which the consumer is a member;
the merchant server being operative:
to interrogate the at least one database to extract information from the at least one database, and
to transmit the extracted information to the communication device;
the communication device being operative:
to display the extracted information to the consumer; and
upon receiving a consumer command, to initiate a payment process in which a payment is made for the selected items.

26. The computerized network according to claim 25, wherein the communication device is additionally operative to:
store a list of the selected product items; and
store and display a cumulative price of the selected product items.

27. The computerized network according to claim 25, wherein the communication device and/or the merchant server is operative, upon completion of the payment process, to generate a digital record of the payment and the purchased products, and store the record in a digital database.

28. The computerized network according to claim 25, wherein the communication device comprises an imaging unit, and is operative to receive the product information encoded within an image captured by the imaging unit; and
wherein the communications device is operative to extract the product information from the captured image in the form of a code number according to a predefined inventory system.

29. (canceled)

30. The computerized network according to claim 25, wherein the payment process initiated by the communication device employs a payment card associated with the consumer.

31. The computerized network according to claim 25, wherein the communication device is operative to transmit identity information to a cash receiving unit.

32. The computerized network according to claim 25, further comprising a scanner unit to identify products being removed from the retail location by the consumer;
wherein the merchant server is arranged to compare the identified products to the selected products to determine if there is a discrepancy between the identified products and the selected products, and to generate an alarm if there is a discrepancy.

33.-40. (canceled)
